(19) United States
(12) Patent Application Publication
(10) Pub. No.: US 2008/0074272 A1
(43) Pub. Date: Mar. 27, 2008

(54) Textile information carrier

(76) Inventors: Anatoli Stobbe, Barsinghausen (DE); Werner Knop, Wennigsen (DE)

Correspondence Address: COLLARD & ROE, P.C., 1077 NORTHERN BOULEVARD, ROSLYN, NY, 11576, US

(21) Appl. No.: 11/821,031

(22) Filed: Jun. 21, 2007

(30) Foreign Application Priority Data
Jun. 23, 2006 (DE) DE102006029 312.6

(51) Int. Cl. G08B 13/14; H04Q 5/22

(52) U.S. Cl. 340/572.7; 340/10.1

(57) ABSTRACT

A textile information carrier is described. This consists of a textile label or textile goods or a tag connected to the goods comprising an electric antenna and a detection wafer comprising an electronic chip module, connected to the textile label, textile goods or the tag. A coupling element connected to the electronic chip module is disposed on the detection wafer, said coupling element being inductively and/or capacitively coupled to the electric antenna of the textile label, the textile goods or the tag.

The invention relates to a textile information carrier cording to the preamble of claim 1.

Textile goods are usually provided with textile labels by the manufacturer, clothing manufacturer, distributor or designer, which contain optically readable information on the composition of the goods, instructions for the care and cleaning and information on the garment size, origin, trademark or trade name as well as the designer.

Especially in high-quality textile goods, designer labels, so-called Jacquard labels are used for identification, or labels printed with the inscription of the producer or the trademark, so-called satin labels are used, these being manufactured in expensive processes to make imitations difficult.

In order to be able to more easily identify imitations or incorrect labels or also to identify textile goods during manufacture, processing, during transportation, during storage, during distribution and during care and cleaning, electronic data carriers are being increasingly used which contain redundant or additional information to the optically readable textile label and which can only be read by means of a special reader. The advantage of information stored on electronic data carriers is that this is largely tamper-proof and insensitive to contamination and cleaning agents and it can also be read without needing to be visible.

As a result of the miniaturised designs of electronic chip modules for the HF, UHF and SHF range, the connection of a textile antenna to connections of the electronic chip module requires a high degree of precision and is very complex to implement in practice. As a result of the textile characteristics of the antenna, the connections are additionally exposed to high mechanical stresses. Added to this are possible thermal and chemical influences during the wearing of the textiles on the body and during cleaning. The reliability of the connection between the textile antennae and the connections of the electronic chip module is thereby impaired.

It is the object of the invention to provide a textile information carrier which allows non-contact coupling between the antenna and the chip module.

This object is achieved by a textile information carrier according to the preamble of claim 1 having the features of this claim.

Further developments and advantageous embodiments are obtained from the dependent claims.

In the textile information carrier according to the invention, the chip module is inductively and/or capacitively coupled to the antenna by means of a coupling element. For this purpose, the chip module together with the coupling element is arranged on a detection wafer. The chip module and the coupling element form an integral unit, the detection wafer. The antenna itself is designed as an electric antenna and requires no galvanic connection to the chip module and coupling element. The combination of the suitably matched coupling element and the antenna also results in an increase in the bandwidth of the entire system whereby it is achieved that the textile information carrier is compatible for operation at different but neighbouring frequencies as a result of different national conditions without design modifications and tuning.

The electric antenna is preferably configured as a dipole, half-wave emitter, full-wave emitter or as a groundplane and the coupling element is arranged at a location of the electric antenna at which a minimum standing wave ratio appears.

The formation of the electric antenna as a dipole, half-wave emitter, full-wave emitter or as a groundplane allows resonant tuning to the working frequency and an antenna gain compared with an isotropic emitter. The arrangement of the coupling loop at a location of the electric antenna where a minimum standing wave ratio appears results in optimum matching and range.

The electric antenna can be mechanically shortened and have a meander-shaped extension inductance.

As a result, matching to the working frequency can be achieved even in textile labels, textile goods or tags whose dimensions are smaller than an integer multiple of the quarter wavelength of the working frequency. The meander-shaped extension inductance allows a representation within one plane and without overlapping of the conductors. Industrial production using conventional textile methods such as weaving or embroidery is possible.

The coupling element is preferably arranged as a coupling loop inside a meander consisting of two parallel conductors and one conductor at right angles thereto.

In this case, it is possible for the coupling loop to be enclosed over up to three quarters of its circumference, which results in close coupling between the coupling loop and the electric antenna.

The electric antenna can be formed from a continuous electric conductor which is brought into resonance by cutting.

The manufacture of the antenna is simplified by processing a continuous textile thread. By cutting the electric conductor, the antenna is formed at the desired location and at the same time is tuned individually in resonance to the working frequency of the detection wafer used.

The detection wafer can be fastened to the textile label, the textile goods or a tag distinguishing the goods by a reversibly detachable or irreversibly undetachable fastening means.

In the case of reversibly detachable detection wafers, the detection wafer can be removed, for example, after a manufacturing, transport or sales process when the information is then no longer required or should not be used by unauthorised persons. In addition, low-value goods can be provided with an inexpensive “disposable” electric antenna and secured at least until sold by temporary installation of a re-usable detection wafer.

In the case of irreversibly undetachably connected detection wafers, the information should remain permanently linked to the textile label, the textile goods or the tag. This makes tampering difficult and impossible without destroying the bond between the textile label, textile goods or tag on the one hand and detection wafer on the other hand.

The fastening means can be configured as at least one mandrel attached to the detection wafer and passing through the textile label, the textile goods or the tag and a button which receives one end of the mandrel and is located on the side of the textile label, the textile goods or the tag opposite to the detection wafer.

This design of the fastening means allows a positive connection and is therefore particularly secure. With a reversibly detachable design, removal is only possible with a special tool to prevent unauthorised removal.

The fastening means can be configured as welding or bonding or pasting or laminating or adhesion or crimping or adhesive film or by means of a patch join produced under heat and pressure.

At the same time, the fastening means can be configured as thermal or reactive adhesive.

The detection wafer is joined directly to the textile label, the textile goods or the tag by fusion of fibres or filaments or indirectly by an adhesive substance. The textile properties of the joined layers comprising the detection wafer and the textile label, the textile goods or the tag are thus retained.

Furthermore, the fastening means can be formed from discrete joining points or very fine, perforated adhesive film.

The restriction to discrete joining points or a very fine, that is thin and flexible, perforated adhesive film avoids any stiffening of the joined layers of the detection wafer and the textile label, the textile goods or the tag.

The fastening means can also be formed from weaving yarns which are laid in the area of the detection wafer above the detection wafer and are woven with the fabric of the textile label, the textile goods or the tag outside the detection wafer.

This makes it possible to achieve an integral fastening of the detection wafer inside a fabric of the textile label, the textile goods or the tag. The joining can be performed within an industrial weaving process.

The fastening means can also be configured as a Velcro closure.

Rapid fastening and releasing of the detection wafer is hereby possible.

The detection wafer can be sealed with a coating.

This coating can effectively protect the detection wafer against mechanical and chemical influences.

The detection wafer can comprise a coupling loop which comprises shortenable coupler structures and can be adapted to the width of the textile label, the textile goods or the tag by cutting off whilst retaining a closed coupling loop.

This design allows a uniform configuration and therefore economic manufacture of the detection wafer for various widths of textile labels, textile goods or tags. Since a closed coupling loop remains even when cutting to a smaller width of detection wafer, close coupling of the coupling loop to the antenna is always ensured.

The detection wafer and/or the textile label, the textile goods or the tag can comprise a multi-part antenna and/or coupling element which only produce frequency and impedance matching jointly and when complementing each other.

The configuration makes tampering difficult by falsifying or simply exchanging textile labels since the entire system requires several components which must be matched to one another.

In a practical embodiment, components of the multi-part antenna and/or coupling elements are attached to different carriers which are locally uniquely assigned amongst one another to ensure the function.

In this case, the local arrangement of the components of the multi-part antenna and/or coupling loop requires particular specialist knowledge to ensure the cooperation of all the components. Tampering is thus made difficult.

At least one partial element of the multi-part antenna and/or the coupling elements can be arranged concealed in the detection wafer and/or in the textile label, in the textile goods or in the tag.

As a result of the structure of the antenna or the coupling elements not being identifiable from outside, it is only possible for persons having specialist knowledge to reconstruct this when removing individual components, and thus tampering is made more difficult.

According to a further development, at least two detection wafers can be provided which can be interrogated jointly.

This further development likewise or additionally allows improved protection against tampering since a function of the entire system is only ensured when information from at least two detection wafers can be interrogated.

The detection wafers can comprise mutually complementary information and can be evaluated as valid or invalid by joint interrogation. Examples of this are items of clothing which belong together such as socks, gloves which contain individual detection wafers with information such as right, left, colour, size but are packaged as a unit in pairs and are provided with a common antenna serving as an amplifier.

This achieves the result that an interrogation is only evaluated as valid in the case of a valid pairing and tampering or confusion can be discovered. The amplifier antenna can also be located in a common package.

Furthermore, the detection wafers can exchange complementary information between one another with the aid of a reader or can be evaluated as valid or invalid by single or joint interrogation.

This allows intelligence of the authentication to be moved into the detection wafers and the information to be transferred via a valid or invalid interrogation can be simplified or made more secure.

The invention is explained hereinafter with reference to exemplary embodiments shown in the drawings.

In the figures:

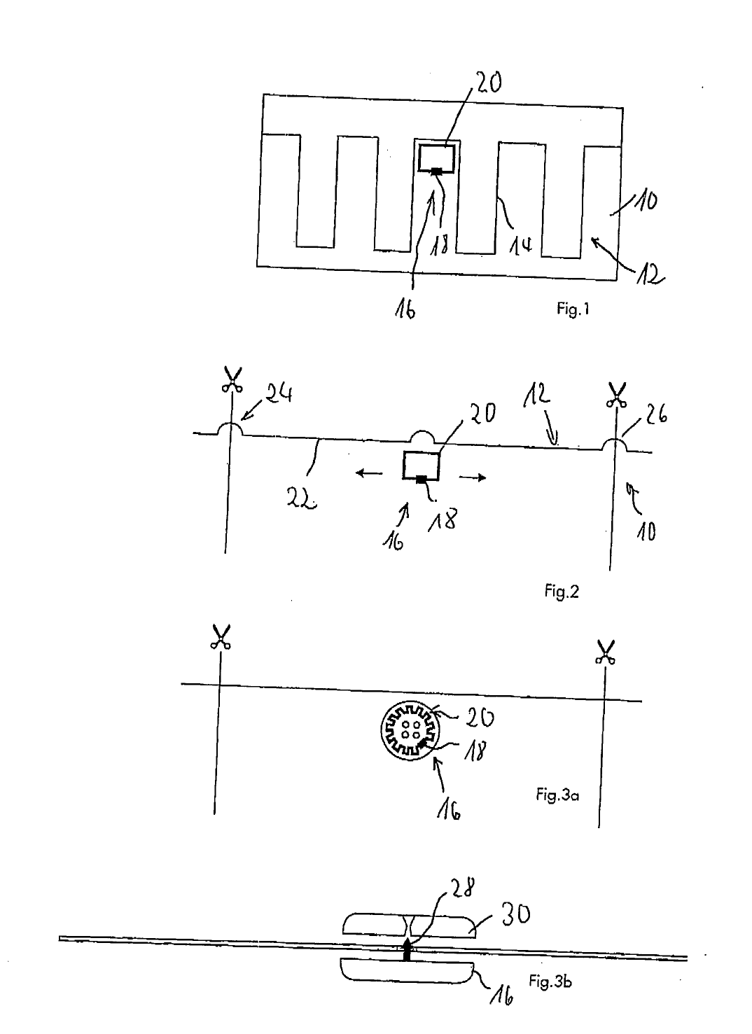

FIG. 1 is a textile unit with an electric antenna as a mechanically shortened dipole and a detection wafer,

FIG. 2 is a textile label with an electric antenna formed from a continuous electrical conductor which is brought into resonance by cutting, and a detection wafer,

FIG. 3a is a plan view of a button-like detection wafer fastened to a textile label,

FIG. 3b is a sectional view of a button-like detection wafer fastened to a textile label comprising a mandrel which passes through the textile label and a counter-button,

FIG. 4a is a detection wafer with fastening means configured as adhesive and a globtop coating,

FIG. 4b is a detection wafer which is pressed head first directly into the adhesive,

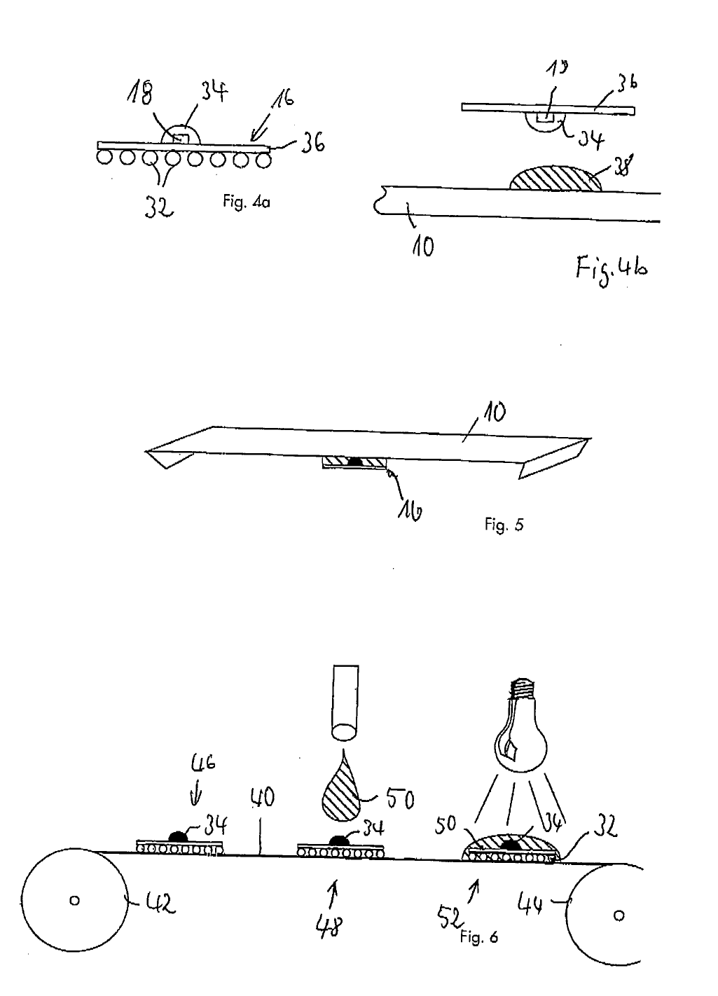

FIG. 5 shows the detection wafer according to FIG. 4b fastened to a textile label,

FIG. 6 shows the detection wafer according to FIG. 4a fastened to a textile strip,

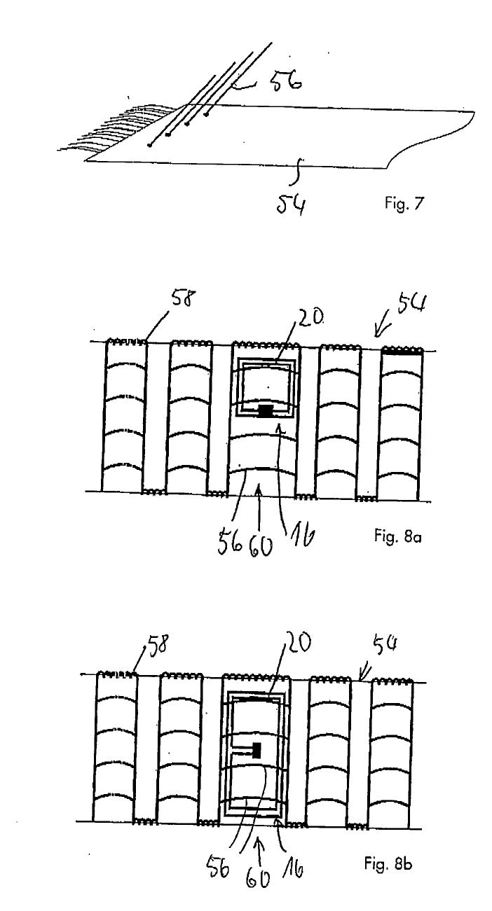

FIG. 7 shows a fabric for receiving a detection wafer,

FIG. 8a is a detection wafer integrated into a fabric strip, having a smaller width than that of the fabric strip

FIG. 8b is a detection wafer integrated into a fabric strip, having the same width as that of the fabric strip,

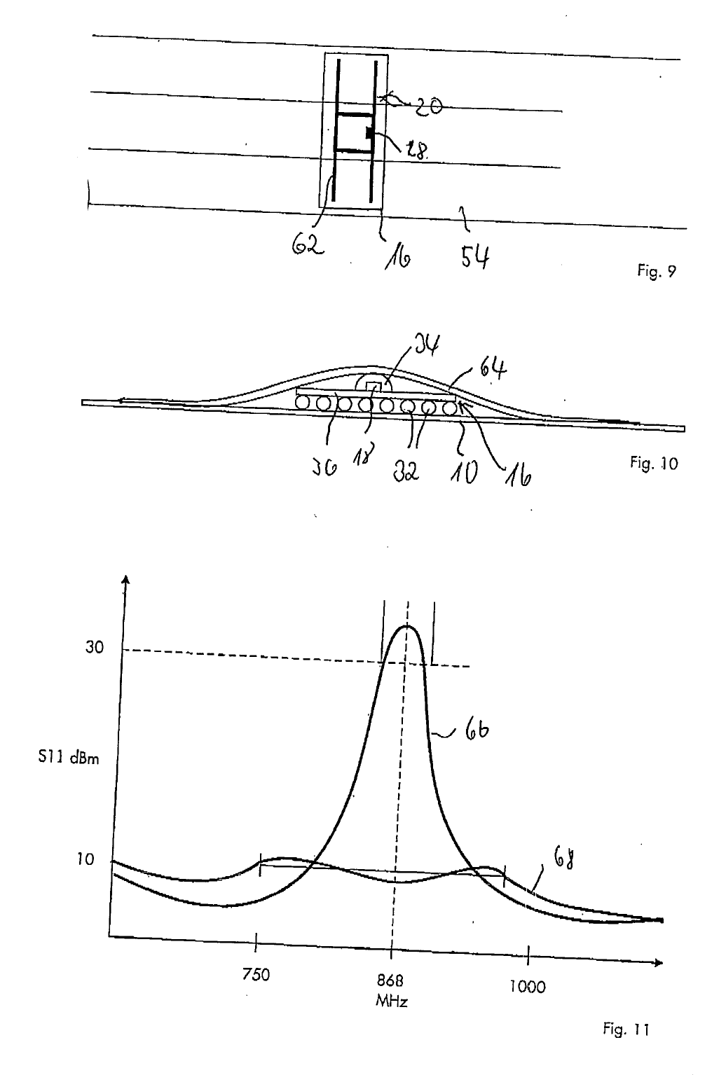

FIG. 9 is a detection wafer comprising a coupling loop consisting of a shortenable coupler structure,

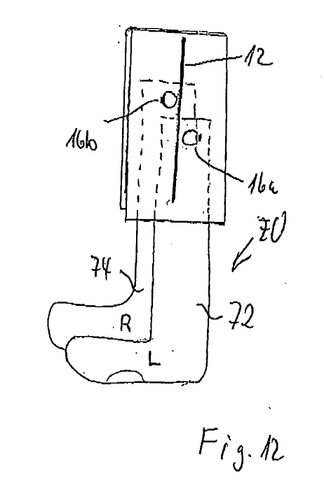

FIG. 10 is a detection wafer fastened to a textile label using a patch,

FIG. 11 is a diagram of the bandwidth of an electric antenna and the entire system and

FIG. 12 is a packaging unit for textile goods which belong together.

FIG. 1 shows a textile unit 10 with an electric antenna 12. The antenna is configured as a mechanically shortened dipole with a meander-shaped extension inductance 14. Located inside a meander 14 at the centre of the antenna 12 is a detection wafer 16 comprising an electronic chip module 18 and a coupling loop 20 connected to the electronic chip module 18. The coupling loop 20 is located at a location of low impedance of the electric antenna 12. As a result of the arrangement within a meander 14 comprising two parallel conductors and one conductor at right angles thereto, inductive coupling with simultaneous impedance matching is achieved between the coupling loop 20 and the electric antenna 12.

FIG. 2 shows another textile label 10 with an electric antenna 12. The antenna 12 is formed from an originally continuous electrical conductor 22 which is cut at two locations 24, 26 and thus forms a dipole. The conductor 22 is cut at locations having a distance of a half-wavelength of the working frequency. As a result, the dipole antenna formed is as the same time tuned in resonance to the working frequency. Located adjacent to the antenna 12 is a detection wafer 16 comprising an electronic chip module 18 and a coupling loop 20 connected to the electronic chip module 18. The coupling loop 20 is located at a location of low impedance of the electric antenna 12, preferably somewhat offset towards the centre. By this means, inductive coupling with simultaneous impedance matching is also achieved between the coupling loop 20 and the electric antenna 12.

FIG. 3a is a plan view of a button-like detection wafer 16 fastened to a textile label and is suitable for the designs according to FIG. 1 and FIG. 2.

FIG. 3b shows a sectional view of the button-like detection wafer 16 comprising a mandrel 28 which passes through the textile label 10 and a counter-button 30. Since this detection wafer 16 is connected positively to the textile label 10, it can be designed as small. It is thus inconspicuous and barely impairs wearing comfort. In addition, it offers little working surface during cleaning and is therefore particularly durable. The connection can be made by pressing together the button components 16; 30. Depending on the design of the connection, this can be released non-destructively, possibly using a special tool or in the case of a locking connection, this can only be released with simultaneous destruction.

FIG. 4a shows a detection wafer 16 with fastening means configured as adhesive 32 and a coating 34. The detection wafer 16 comprises a soft, flexible film 36 which adapts flexibly to a textile label, to textile goods or to a tag. The adhesive 32 can be a thermal or reactive adhesive which bonds with the threads of the textile label, the textile goods or the tag. A coating 34 with globtop material offers protection from mechanical, thermal and chemical influences. A further coating can at the same time form an adhesive surface when the detection wafer with the chip module is adhesively bonded in the direction of the textile label, the textile goods or the tag to said textile label, textile goods or tag.

Alternatively, as shown in FIG. 4b, an adhesive 38 can be applied to the textile label 10 itself and then the detection wafer 16 is pressed head first into the adhesive.

FIG. 5 shows the detection wafer 16 according to FIG. 4b fastened to a textile label 10. The detection wafer 16 is adhesively bonded here to the invisible back side of the textile label 10.

FIG. 6 shows the detection wafer 16 according to FIG. 4a as fastened at uniform distances on a textile strip 40 in an assembly process. The textile strip 40 runs from a supply roll 42 to a finished roll 44. In a first station 46 a detection wafer 16 wetted with a reactive adhesive 32 is placed on the textile strip 38, in a second station 48 a silicone coating is applied and in a third station 52 the reactive adhesive 32 is activated by UV light. When using a structure according to FIG. 4b, the detection wafer 16 can be pressed headfirst into a drop of adhesive.

FIG. 7 shows a fabric 54 for receiving a detection wafer 16. The fabric 54 is produced on a loom which comprises an additional compartment for independent control of a portion of the warp thread 56. In this way, it is possible to alternately weave first all the warp threads and then only some of the warp threads and guide the other warp threads 56 further on the fabric 54. A receiving chamber for detection wafers is thus formed, which is defined on one flat side by a woven surface of warp and weft threads and on the other flat side by unwoven warp threads 56. At the side, the chamber is again defined by the completely woven warp and weft threads. At the same time, an electrically conducting warp weft thread can be guided in a meander form and form an extension inductance.

FIGS. 8a and 8b show fabric strips 54 fabricated according to FIG. 7 with a meander-shaped electrically conducting weft thread 58 and chambers 60 for receiving a detection wafer 16. In FIG. 8a the detection wafer 16 extends over only a part of the width of the textile strip 54. With the coupling loop 20 arranged on the detection wafer 16, close coupling with a meander of the antenna 58 can be achieved regardless of the width of the textile strip 54, but this variant would result in a sloping position of the reel when the textile strip 54 is wound onto a roll.

In FIG. 8b the detection wafer 16 extends over the total width of the textile strip 54. A sloping position of the reel is thus avoided when winding the textile strip onto a roll.

In order that standard detection wafers 16 can be used for textile strips 54 of different width, FIG. 9 shows a variant with a coupling loop 20 comprising a shortenable coupling structure 62. If the textile strip 54 is narrower than the original detection wafer 16, the detection wafer 16 can be adapted to the width of the textile strip 54 by cutting whilst retaining a closed coupling loop 20.

FIG. 10 shows a detection wafer 16 fastened to a textile label 10 using a patch 64. The patch 64 has a coating with a thermal adhesive. The patch 64 laid over the detection wafer 16 is fastened to the textile label 10 by pressure and heat. The detection wafer 16 is thus enclosed and thus simultaneously fastened on the textile label 19 and covered.

FIG. 11 shows a diagram of the bandwidth of an electric antenna as curve 66 and the entire system as curve 68. Shown here as an example is an antenna whose resonance frequency corresponds to a first permitted working frequency of 886 MHz.

The diagram shows that at a second permitted working frequency of 915 MHz, the antenna would already be outside its optimum. In conjunction with the coupling element, however, a broad-band characteristic of the entire system is obtained so that no matching to different national standards is required.

FIG. 12 shows a packaging unit 70 for textile goods which belong together, in this case a pair of stockings 72, 74. Each stocking has its own detection wafer 16a, 16b which comprises additional information about size, as well as right and left. The two detection wafers 16a, 16b are coupled to a common electric antenna 12 as an amplifier antenna and are evaluated by a joint interrogation.

1: A textile information carrier, consisting of a textile label, textile goods or a tag connected to the goods comprising an electric antenna and a detection wafer comprising an electronic chip module, connected to the textile label, textile goods or the tag, wherein a coupling element connected to the electronic chip module is disposed on the detection wafer, said coupling element being inductively and/or capacitively coupled to the electric antenna of the textile label, the textile goods or the tag.

2: The textile information carrier according to claim 1, wherein the electric antenna is configured as a dipole, half-wave emitter, full-wave emitter or as a groundplane and the coupling element is arranged at a location of the electric antenna at which a minimum standing wave ratio or an optimum bandwidth of the entire system on an optimum antenna gain occurs.

3: The textile information carrier according to claim 1, wherein the electric antenna is mechanically shortened and has a meander-shaped extension inductance.

4: The textile information carrier according to claim 3, wherein the coupling element follows the profile of the electric antenna over one section.

5: The textile information carrier according to claim 3, wherein the coupling element is configured as a coupling loop and is disposed inside a meander consisting of two parallel conductors and one conductor at right angles thereto.

6: The textile information carrier according to claim 1, wherein the electric antenna is formed from a continuous electric conductor which is brought into resonance by cutting.

7: The textile information carrier according to claim 1, wherein the detection wafer is fastened to the textile label, the textile goods or the tag by a reversibly detachable or irreversibly undetachable fastening means.

8: The textile information carrier according to claim 7, wherein the fastening means is configured as at least one mandrel attached to the detection wafer and passing through the textile label, the textile goods or the tag and a button which receives one end of the mandrel and is located on the side of the textile label, the textile goods or the tag opposite to the detection wafer.

9: The textile information carrier according to claim 7, wherein the fastening means is configured as welding or bonding or pasting or laminating or adhesion or crimping or adhesive film or by means of a patch join produced under heat and pressure.

10: The textile information carrier according to claim 7, wherein the fastening means is configured as thermal or reactive adhesive.

11: The textile information carrier according to claim 7, wherein the fastening means is formed from discrete joining points or very fine, perforated adhesive film.

12: The textile information carrier according to claim 7, wherein the fastening means is formed from weaving yarns which are laid in the area of the detection wafer above the detection wafer and are woven with the fabric of the textile label, the textile goods or the tag outside the detection wafer.

13: The textile information carrier according to claim 7, wherein the fastening means is configured as a Velcro closure.

14: The textile information carrier according to claim 1, wherein the detection wafer is sealed with a coating.

15: The textile information carrier according to claim 14, wherein the coating at the same time forms an adhesive surface.

16: The textile information carrier according to claim 1, wherein the detection wafer comprises a coupling loop which comprises a shortenable coupler structure and can be adapted to the width of the textile label, the textile goods or the tag by cutting off whilst retaining a closed coupling loop.

17: The textile information carrier according to claim 1, wherein the detection wafer and/or the textile label, the textile goods or the tag comprises a multi-part antenna and/or coupling element which only produce frequency and impedance matching jointly and when complementing each other.

18: The textile information carrier according to claim 17, wherein the components of the multi-part antenna and/or coupling elements are attached to different carriers which are locally uniquely assigned amongst one another to ensure the function.

19: The textile information carrier according to claim 17, wherein at least one partial element of the multi-part antenna and/or the coupling elements is arranged concealed in the detection wafer and/or in the textile label, in the textile goods or in the tag.

20: The textile information carrier according to claim 1, wherein at least two detection wafers are provided which can be interrogated jointly.

21: The textile information carrier according to claim 20, wherein at least two spatially separate detection wafers have a common electric antenna.

22: The textile information carrier according to claim 20, wherein the detection wafers comprise mutually complementary information and are evaluated as valid or invalid by joint interrogation.

23: The textile information carrier according to claim 20, wherein the detection wafer exchange complementary information between one another with the aid of a reader or are evaluated as valid or invalid by single or joint interrogation.
